(19) United States
(12) Patent Application Publication
(10) Pub. No.: US 2008/0248342 A1
(43) Pub. Date: Oct. 9, 2008

(54) SOLID OXIDE FUEL CELL POWER GENERATION APPARATUS AND POWER GENERATION METHOD THEREOF

(75) Inventors: Shin Takahashi, Hitachi (JP); Hiromi Tokoi, Tokai (JP); Akira Gunji, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/099,192

(22) Filed: Apr. 8, 2008

(30) Foreign Application Priority Data
Apr. 9, 2007 (JP) 2007-101797

(51) Int. Cl. H01M 8/04

(52) U.S. Cl. 429/13; 429/26; 429/24; 429/22

(57) ABSTRACT

A solid oxide fuel cell power generation apparatus, wherein cathode gas lines used for activation and used for power generation line are separated from each other, wherein a burner used for activation is disposed close to a header above a generator chamber inside a module, and a preheater used for power generation is also disposed at a position further away from the generator chamber (including fuel cells) inside the module than the burner used for activation is.

### CROSS-REFERENCE TO RELATED APPLICATION

The present application relates to subject matters described in a co-pending patent application Ser. No. 11/835,454 filed on Aug. 8, 2007 entitled “FUEL CELL POWER GENERATION SYSTEM AND METHOD OF OPERATING THEREOF” by Shin Takahashi, et al. and assigned to the assignee of the present application. The disclosures of this co-pending application are incorporated herein by reference.

### BACKGROUND OF THE INVENTION

The present invention relates to improvements in a solid oxide fuel cell power generation apparatus and a method of operating the same.

A fuel cell power generation apparatus comprises an anode and a cathode on both sides of an electrolyte, wherein a fuel gas is supplied to the anode side and an oxidant gas (mainly air) is supplied to the cathode side so that the fuel and the oxidant are electrochemically reacted with each other via the electrolyte, thereby performing power generation. Researches toward practical use are now being conducted concerning a solid oxide fuel cell, which is one type of fuel cells. This is because in the solid oxide fuel cell, the operation temperature is high, i.e., about 700 to 1000° C. and the power generation efficiency is high, and the exhaust heat is also easily used.

Usually, a fuel cell constitutes an assembly (module) in which several tens of to several hundreds of cells are stacked in order to obtain electric power. Usually, in this module, power generation is performed after the temperature thereof is raised by an external heat source, such as a burner or a heater, to a predetermined temperature (e.g., around 600° C.) at which power generation is possible. However, in order to raise the temperature to this temperature, it takes time and energy loss is also high, which thereby reduces the usability of the solid oxide fuel cell.

Moreover, during power generation, these external heat sources can be stopped and the fuel cell system can be thermally self-sufficient by the power generation reaction of the fuel cell. However, in order to do this, the temperature of the supply gas during power generation needs to be properly controlled with the exhaust heat from the fuel cell. In other words, for the solid oxide fuel cell, there is a desire to achieve a reduction in the activation time, a reduction in the activation energy, as well as the temperature maintenance and performance improvements at the same time.

For the raising temperature of the modular, JP-A-2004-119299 discloses an example of disposing a heater in an air flow channel.

Moreover, for the temperature maintenance of the module, JP-A-2004-71312 discloses an example in which air is passed through a bypass path provided with a thermal storage medium during a partial load operation.

### SUMMARY OF THE INVENTION

The problem here is that since a heating means used for activation such as an electric type air heater in JP-A-2004-119299 is disposed outside the module, heat will escape on the way, so that a high temperature gas can not be effectively supplied, which makes it difficult to facilitate the heating.

Moreover, since the heating means used for activation is disposed outside the modular, the whole system becomes large, so that the radiation amount becomes large, thereby reducing the efficiency.

Namely, in the prior art, the activation time is long and the activation energy loss is high. Moreover, the supply temperature of a gas required during power generation is difficult to maintain.

It is an object of the present invention to provide a solid oxide fuel cell power generation apparatus that reduces the activation time and improves the efficiency.

It is another object of the present invention to provide a solid oxide fuel cell power generation apparatus that achieves a reduction in the activation time and an improvement in the efficiency as well as the temperature maintenance and performance improvements during operation at the same time.

It is yet another object of the present invention to provide a power generation method of a solid oxide fuel cell power generation apparatus that achieves a reduction in the activation time and an improvement in the efficiency.

It is yet another object of the present invention to provide a power generation method of a solid oxide fuel cell power generation apparatus that achieves a reduction in the activation time and an improvement in the efficiency as well as the temperature maintenance and performance improvements during operation at the same time.

According to claim an aspect of the present invention, there is provided a modular structure wherein gas supply lines used for module heating (activation) and used for power generation are disposed independently from each other inside a fuel cell module.

Moreover, according to claim another aspect of the present invention, a fuel cell module includes a generator chamber in which a plurality of fuel cells are assembled, wherein gas supply lines used for module heating and used for power generation are switched and operated.

Moreover, according to claim yet another aspect of the present invention, a fuel cell module includes a distributor (header) of gasses supplied to the generator chamber, wherein the distributor includes two sets of gas supply ports for independently supplying gases used for activation and used for power generation.

Moreover, according to claim yet another aspect of the present invention, in the gas supply line to the generator chamber, a gas heating means used for activation is disposed close to the cell, and a gas preheater used for power generation is disposed further away from the fuel cell than this gas heating means used for activation is.

Moreover, according to claim yet another aspect of the present invention, a header for supplying a gas to the generator chamber and a preheater used for power generation are integrated into one.

According to claim a preferable embodiment of the present invention, by disposing gas supply lines used for activation and used for power generation separately from each other inside the fuel cell module, it is possible to achieve a reduction in the activation time and a reduction in the activation energy.

Moreover, according to claim a preferable embodiment of the present invention, by separating supply lines used for activation and used for power generation from each other, it is possible to achieve a reduction in the activation time, a reduction in the activation energy as well as the temperature maintenance and performance improvements during power generation at the same time. In the following description, a term “a solid oxide fuel cell” is used to indicate a solid oxide fuel cell power generation apparatus or to indicate a fuel cell unit 1 of solid oxide fuel cell power generation apparatus.

Other objects, features and advantages of the invention will become apparent from the following description of the embodiments of the invention taken in conjunction with the accompanying drawings.

### BRIEF DESCRIPTION OF THE DRAWINGS

FIG. 1 is a vertical cross sectional side view of a solid oxide fuel cell power generation apparatus according to Embodiment 1 of the present invention.

FIG. 2 is an A-A cross sectional view of FIG. 1.

FIG. 3 is an enlarged vertical cross sectional side view of a single cell according to Embodiment 1 of the present invention.

FIG. 4 is an example graph of the temperature rising characteristic in a first operation method in Embodiment 1 of the present invention.

FIG. 5 is an example diagram of the temperature rising characteristic in a second operation method of performing power generation during combustion of a burner in Embodiment 1 of the present invention.

FIG. 6 illustrates a vertical cross sectional side view of a cell module of a solid oxide fuel cell according to Embodiment 2 of the present invention and a control block diagram thereof.

FIG. 7 illustrates a vertical cross sectional side view of a cell module of a solid oxide fuel cell according to Embodiment 3 of the present invention.

### DESCRIPTION OF THE EMBODIMENTS

Hereinafter, the preferable embodiments of the present invention will be described in detail with reference to the accompanying drawings.

### Embodiment 1

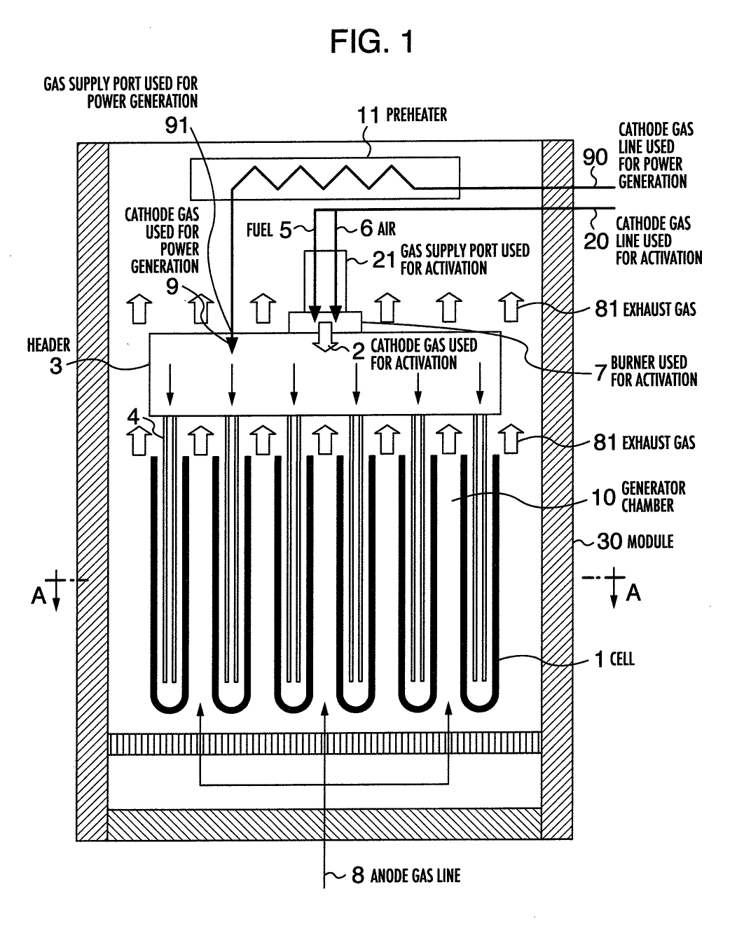

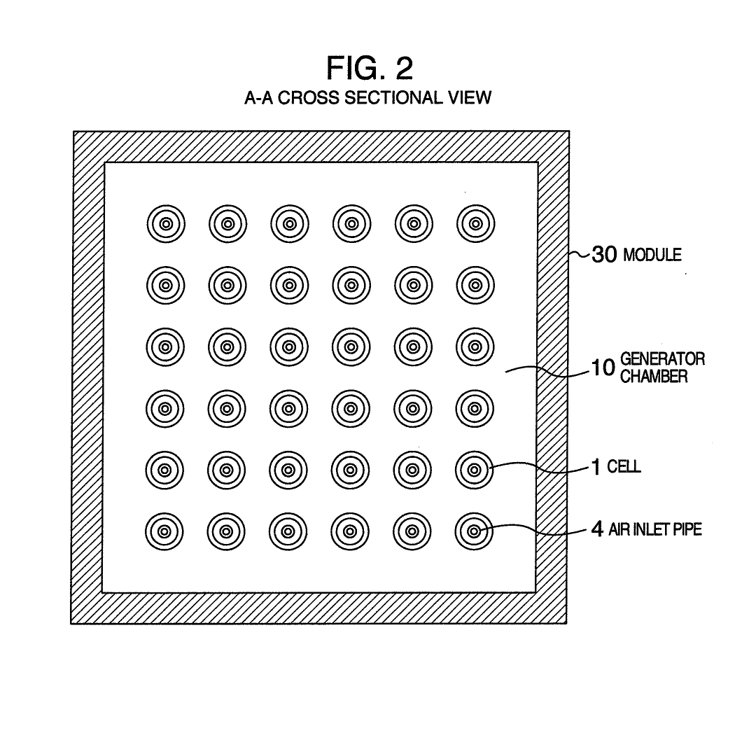

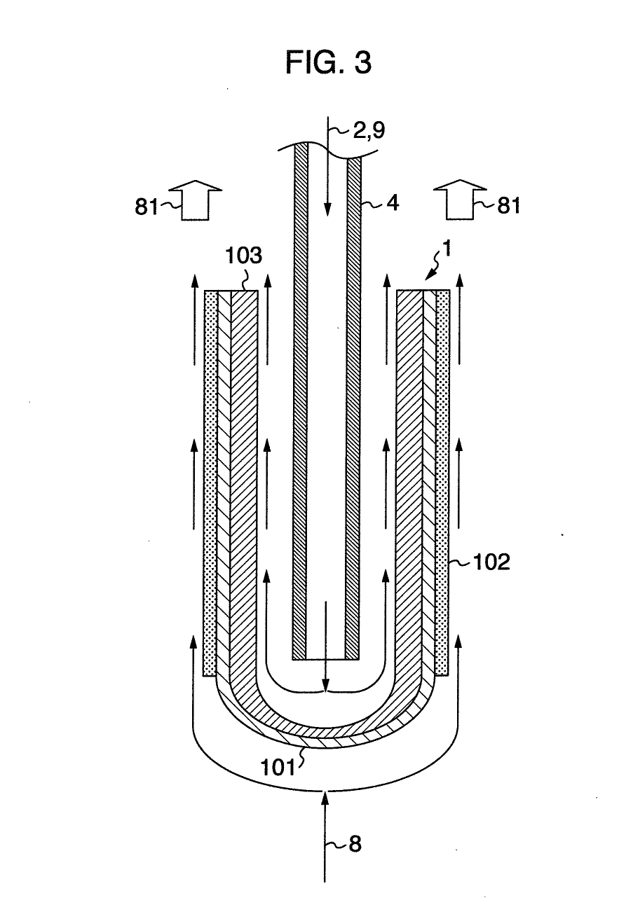

FIG. 1 is a vertical cross sectional side view of a solid oxide fuel cell power generation apparatus according to Embodiment 1 of the present invention, FIG. 2 is an A-A cross sectional view of FIG. 1, and FIG. 3 is an enlarged vertical cross sectional side view of a single cell.

In the basic structure of a solid oxide fuel cell 1, as illustrated in FIG. 3, a cylindrical solid oxide electrolyte 101 is sandwiched by an anode 102 from the inside thereof and a cathode 103 from the outside thereof. In FIG. 2, thirty-six solid oxide fuel cells 1 are illustrated for convenience. However, usually, about several tens to several hundreds of solid oxide fuel cells 1 are stacked and assembled in series or in parallel to constitute a generator chamber 10 for performing power generation. FIG. 1 as a whole, which is an assembly of these cells, is referred to as a fuel cell module 30.

On the cathode 103 side of the fuel cell 1, an oxidant gas (air or a combustion gas) is flown as cathode gases 2, 9. Among these, the cathode gas 2 used for activation is supplied from a gas supply port 21 used for activation, while the cathode gas 9 used for power generation is supplied from a gas supply port 91 used for power generation. These cathode gases 2, 9 pass through a header 3 for equally distributing the cathode gas to an air inlet pipe 4 to each fuel cell 1 inside a generator chamber 10, and reach the cathode 103 of each fuel cell 1.

In a preferable embodiment of the present invention, a burner 7 used for activation is disposed close to the air header 3 inside the fuel cell module 30, as shown in FIG. 1.

Now, during activation, prior to power generation, firstly, the temperature of the fuel cell is raised to about 600 to 700° C., which is the minimum temperature at which power generation can be started. From a cathode gas line 20 used for activation, fuel 5 and air 6 are supplied to the burner 7 used for activation to produce the high temperature cathode gas 2 used for activation, and the heating is continued using this high temperature gas.

At this time, since the burner 7 used for activation is disposed close to the air header 3, the cathode gas 2 used for activation heated by the burner 7 used for activation is less likely to be cooled in the middle of the supply to the header 3. Therefore, the high temperature cathode gas 2 used for activation can be effectively supplied to the fuel cell 1 inside the generator chamber 10, and heating the module can be effectively promoted. Note that the burner 7 used for activation described here is just an example, and the bottom line is that a heating means for supplying a high temperature gas to the fuel cell 1 and thereby raising the temperature thereof is required.

Thereafter, upon reaching a temperature at which power generation can be started, the supply of the fuel 5 used for activation is cut off and the burner 7 used for activation is stopped, and at the same time a fuel gas from an anode gas line 8 and the cathode gas 9 used for power generation are supplied to the solid oxide fuel cell 1 to start power generation.

As the fuel gas supplied from the anode gas line 8, a reformed gas obtained by steam-reforming a part or whole of a mixed gas of a hydrocarbon-based fuel such as a town gas, LNG, or LPG, and water vapor by means of a reformer is used. Since the fuel cell 1 generates heat during power generation, the system is thermally independently operated at about 700-1000° C. using this heat. The anode gas and cathode gas that did not cause power generation (chemical) reaction are burned into an exhaust gas 81 on the outlet side of the fuel cell 1.

Now, the air distribution header 3 has two supply ports, i.e., a supply port 21 to which the high temperature cathode gas 2 used for activation is supplied, and a supply port 91 to which the cathode gas 9 used for power generation is supplied, and has a system configuration in which the cathode gas line 20 used for activation and a cathode gas line 90 used for power generation are separately formed. A supply port 91 of this cathode gas line 90 used for power generation is provided via a preheater 11 by means of a metal pipe. This preheater 11 to operate during power generation is also disposed inside the fuel cell module 30. Accordingly, the cathode gas 9 used for power generation heated by the preheater 11 is less likely to be cooled in the middle of the supply to the header 3. Therefore, the high temperature cathode gas 9 used for power generation can be supplied to the fuel cell 1 inside the generator chamber 10 and highly efficient power generation can be promoted.

According to this embodiment, during activation, the fuel 5 and air 6 are supplied to the burner 7 used for activation disposed close to the header 3 and then are burned to thereby produce the high temperature cathode gas 2. Then, the high temperature cathode gas 2 is supplied to the closest cell 1 to thereby facilitate raising the temperature of the whole fuel cell module 30. It is therefore possible to achieve a reduction in the activation time and a reduction in the activation energy.

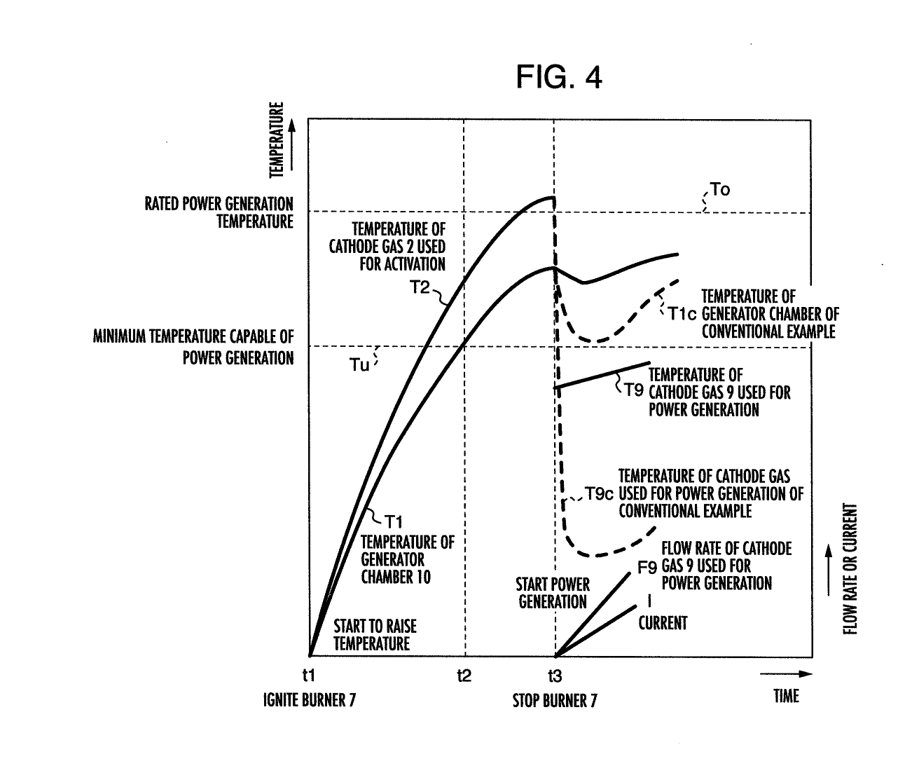

FIG. 4 is an example graph of the temperature rising characteristic in a first operation method in Embodiment 1 of the present invention.

In this system, at a time point t1, the burner 7 is ignited to start raising temperature, and the module 30 is heated with the cathode gas 2 used for activation. Then, at a time point t2, if the temperature T1 of the generator chamber 1 exceeds the minimum temperature at which power generation is possible, e.g., Tu=600° C., then this fact is detected, and at a time point t3, the burner 7 used for activation is stopped and at the same time a supply of the fuel gas is started from the anode gas line 8 to start power generation.

Conventionally, at this time, if the burner 7 is stopped at the time point t3, a temperature T9c of the cathode gas 9 used for power generation decreases abruptly and a temperature T1c of the generator chamber 10 also decreases abruptly as shown in FIG. 4 since the cathode gas line used for activation and the cathode gas line used for power generation are the same. Due to this abrupt change in the temperature T1c of the generator chamber, a thermal stress to the fuel cell 1 will occur, and the cell made of ceramics is broken in the worst-case scenario.

In contrast thereto, in Embodiment 1 of the present invention, the cathode gas line 90 used for power generation including the preheater 11 is provided independently of the cathode gas line 20 used for activation. For this reason, after the stop of the burner 7 used for activation, the cathode gas 9 used for power generation preheated by recovering the heat of the exhaust gas 81 can be supplied to the fuel cell 1 inside the generator chamber 10, so that a low-temperature gas will not be directly supplied to the fuel cell 1. Accordingly, as shown in FIG. 4, the generator chamber temperature T1, although exhibiting only a slight decline, is kept at a high temperature sufficient for power generation, so that the power generation performance can be improved. Of course, there is no danger of causing a cell breakage associated with an abrupt change in the temperature, so that high reliability can be achieved.

The high temperature cathode gas 2 used for activation during activation can be produced by supplying the fuel 5 and air 6 from the gas supply port 21 used for activation to the burner 7 used for activation and by burning the same. Then, this high temperature cathode gas 2 used for activation can be supplied to the closest fuel cell 1. Accordingly, raising the temperature of the module 30 becomes easy, so that a reduction in the activation time and a reduction in the activation energy can be attained. Moreover, independently of this line used for activation, the cathode gas line 90 used for power generation is provided and the preheater 11 is provided, so that after the stop of the burner 7, the air preheated by recovering the heat of the exhaust gas 81 can be supplied to the fuel cell 1 as the cathode gas 9 used for power generation. For this reason, a low-temperature gas will not be directly supplied to the inside of the generator chamber 10, so that the temperature maintenance of the module 30 and a reduction of the temperature distribution thereof can be attained and the power generation performance can be improved.

These two effects can be achieved by firstly the fact that as shown in FIG. 1, the burner 7 used for activation is disposed inside the module 30 and also at a position close to the cell, and secondly the fact that the power generation preheater 11 is disposed on the further side from the cell inside the module 30 than the burner 7 used for activation is.

Furthermore, as describes below, the present invention also facilitates to perform power generation during combustion of the burner 7 used for activation.

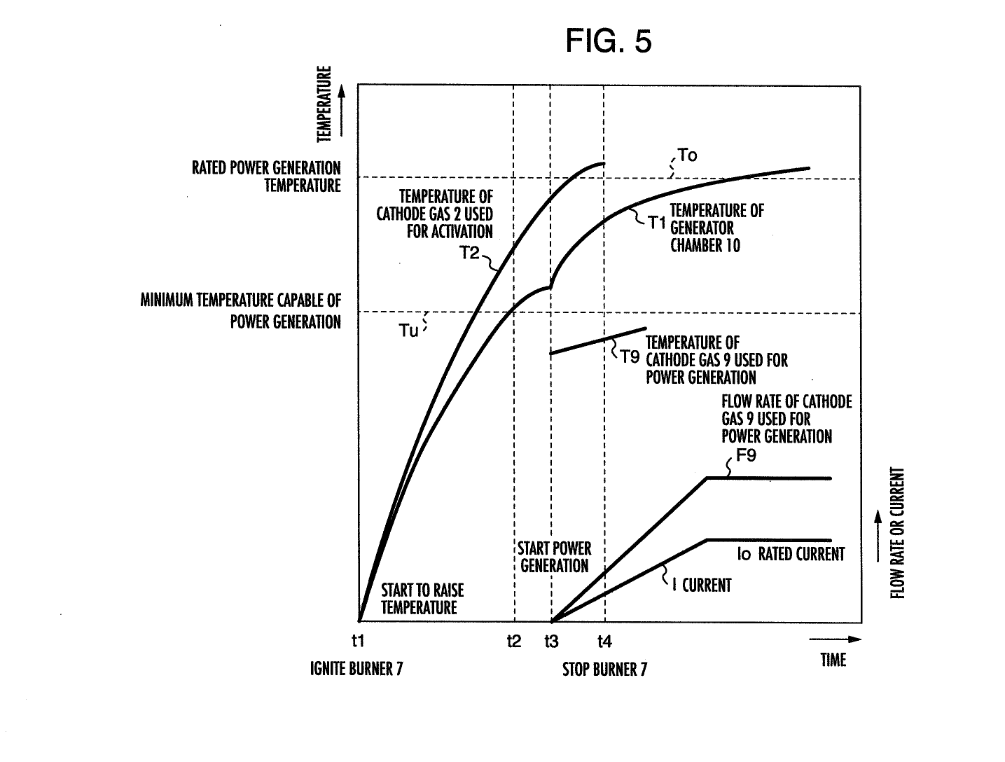

FIG. 5 is an example graph of the temperature rising characteristic in an operation method of performing power generation during combustion of the burner, with the use of the solid oxide fuel cell according to claim Embodiment 1 of the present invention.

In order for the solid oxide fuel cell to perform power generation, a specified amount of air is required. However, even if attempting to supply this specified amount of air for power generation from the same gas line for the burner during combustion of the burner 7, unless the ratio of the fuel 5 and air 6 and the temperature thereof are kept in an appropriate range in order for the burner 7 to stably burn the mixture of the fuel and air, the burner will misfire or backfire. For example, the mole ratio (equivalent ratio) of the fuel to air when the burner 7 burns the mixture of the fuel and air is typically in the range of about 0.5 to 0.8. Accordingly, if the equivalent ratio is reduced from this range by increasing air in order to generate power, the burner 7 will misfire.

Alternatively, if the amount of fuel supply is reduced to increase the amount of air, the supply flow rate of the fuel decreases or the fuel temperature increases, which will increase the likelihood of backfire. It is therefore difficult to supply the gas used for power generation from an identical line during combustion of the burner 7.

Then, in a preferable embodiment of the present invention, the cathode gas line 20 used for activation and the cathode gas line 90 used for power generation are separated from each other, so that the gas required for power generation can be supplied independently of the gas supply port used for power generation 91 without being aware of the combustion state of the burner 7.

As shown in FIG. 5, at a time point t3 during combustion of the burner 7 used for activation, the cathode gas 9 used for power generation is supplied to the module 30 through the preheater 11 to start power generation. In this way, Joule heating during power generation also can be used in heating, while supplying a high temperature gas generated during combustion of the burner 7 to the module 30. For this reason, as illustrated, after the time point t3, the increase in the temperature T1 of the generator chamber 10 inside the module 30 is accelerated, and also the reduction in the temperature raising time can be achieved. Subsequently, at a time point t4, the burner 7 is completely stopped.

Since this operation method can gradually switch to power generation without completely stopping the combustion of the burner 7, this method also provides the effect that, as compared with the operation method shown in FIG. 4, a change in the generator chamber temperature T1 inside the module 30 when the burner 7 is stopped can be further reduced and the breakage of the cell 1 can be prevented.

Furthermore, a large amount of heat of the exhaust gas 81 that is conventionally discarded during combustion of the burner is recovered by the preheater 11 and supplied to the generator chamber in this embodiment, so that the heat loss is reduced, the activation energy is reduced, and an efficient system can be obtained.

### Embodiment 2

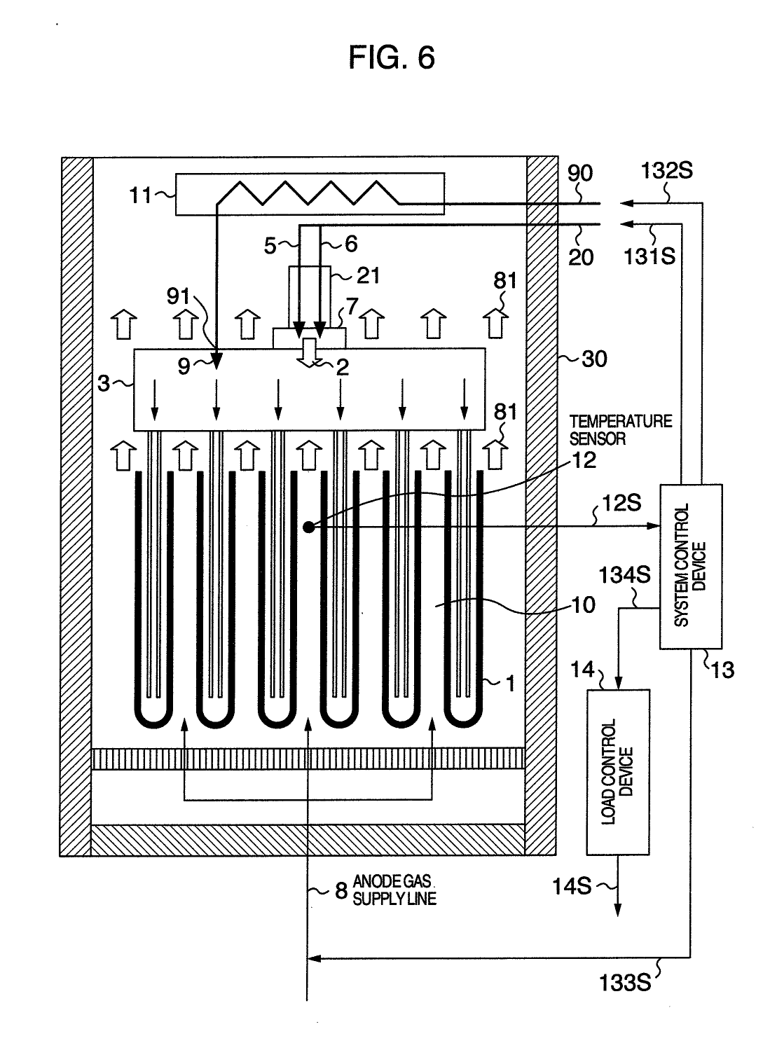

FIG. 6 illustrates a vertical cross sectional side view of a cell module of a solid oxide fuel cell and a control block diagram, according to Embodiment 2 of the present invention. Embodiment 2 illustrates a system that performs the control as described above by detecting the generator chamber temperature by means of a temperature sensor 12 provided in the generator chamber 10 inside the module 30 and then by transmitting this as a detection signal 12S to a system controller 13.

Information of the temperature T1 of the generator chamber is inputted as the detection signal 12S to the system controller 13 by the temperature sensor 12. In response to this, the system control device 13 functions so as to optimize the temperature raising speed of the generator chamber 10.

Referring to FIG. 4 first, upon receipt of an activation instruction at the time point t1, a control signal 131S causes to start a supply of the cathode gas 2 used for activation composed of the fuel 5 and air 6 from the cathode gas line 20 used for activation and cathode gas supply port 21 used for activation. At the same time, the burner 7 used for activation is ignited to increase the activation gas temperature T2 and the generator chamber temperature T1 as shown in FIG. 4.

If at the time point t2 the signal 12S from the temperature sensor 12 detects that the generator chamber temperature T1 exceeded the minimum temperature Tu at which power generation is possible, then at the time point t3, the supply of the fuel 5 used for activation is cut off and the burner 7 is stopped by the control signal 131S. On the other hand, by means of a control signal 132S, the cathode gas line 20 used for power generation is activated to start a supply of the cathode gas 9 used for power generation and at the same time the anode gas supply line 8 is activated to start a supply of the fuel for power generation. The temperature of the gas 9 used for power generation in this case is as shown in FIG. 4, where the fuel cell starts power generation from the time point t3. Also thereafter, the control signal 132S and control signals 133S, 134S are transmitted to the cathode gas line 90 used for power generation, the anode gas line 8, and a load control device 14, respectively, so that the generator chamber temperature T1 may keep a predetermined appropriate temperature. These control signals control the temperature and flow rate of the cathode gas 9 used for power generation (mainly composed of air) from the cathode gas line 90 used for power generation as well as the supply of the fuel gas from the anode gas line 8. Moreover, a control signal 14S from the load control device 14 controls a load (not shown) of the cell, specifically the generated current value as the module 30.

A reduction in the activation time, a reduction in the activation energy as well as the temperature maintenance and performance improvements during power generation can be achieved at the same time by such control.

Note that although this embodiment showed an example of control based on the temperature signal 12S from the temperature sensor 12, the control system is not limited to this. For example, it is also possible to switch over to power generation by counting sufficient time after igniting the burner 7.

### Embodiment 3

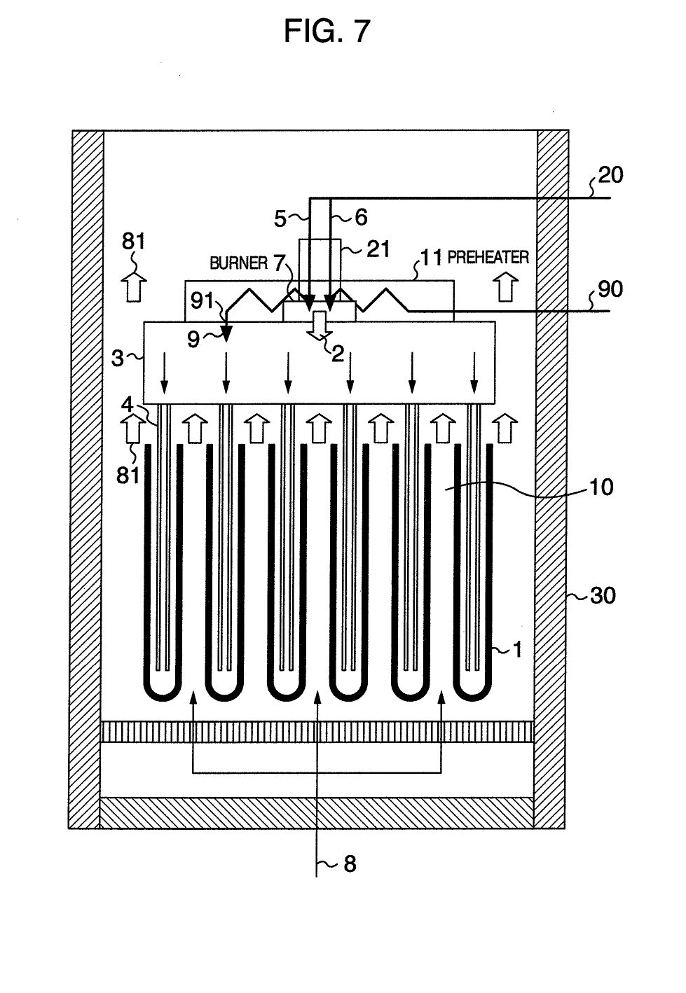

FIG. 7 illustrates a vertical cross sectional side view of a cell module of a solid oxide fuel cell according to Embodiment 3 of the present invention. In this Embodiment 3, the preheater 11 is disposed right on the header 3 to be integrated therewith, and other configurations are the same as those of the embodiment of FIG. 1, so the duplicated description is avoided.

In this structure, a container plane constituting the header 3 and the preheater 11 are in contact with each other over a wide area between metals. For this reason, more heat of the exhaust gas 81 can be conducted to the preheater 11 by heat conduction through the header 3, so that the preheating performance is improved than in the embodiment of FIG. 1. Thus, it is possible to achieve further reduction in the activation time and reduction in the activation energy as well as the temperature maintenance and performance improvements during power generation. Moreover, since the system becomes compact due to the integration of the preheater 11 and the header 3, the installation volume of the whole system can be reduced and the heat radiation can be reduced, so that an improvement in the efficiency can be also achieved.

Note that the present invention, although illustrated as a cylindrical shape in the above embodiments, can be applied, of course, to the case of a solid oxide fuel cell having a flat shape other than the cylindrical shape.

Furthermore, in the above embodiments, a system configuration has been described in which only the gas supply line on the cathode side is separated during activation and during power generation, however, also with the same configuration on the anode side, the effects of the present invention can be obtained, of course.

Since the present invention can achieve a reduction in the activation time of a solid oxide fuel cell, a reduction in the activation energy thereof as well as the temperature maintenance and performance improvements thereof at the same time, the solid oxide fuel cell of the present invention can be used as an earth environment-friendly distributed power supply system.

It should be further understood by those skilled in the art that although the foregoing description has been made on embodiments of the invention, the invention is not limited thereto and various changes and modifications may be made without departing from the spirit of the invention and the scope of the appended claims.

1. A solid oxide fuel cell power generation apparatus, comprising:
a plurality of fuel cells each having an anode on one side and a cathode on the other side with an electrolyte provided therebetween;
a fuel cell module including a generator chamber for housing the plurality of fuel cells;
an anode gas supply line that supplies an anode gas used for power generation from one side of the fuel cell module; and
a cathode gas supply line that supplies a cathode gas used for power generation from the other side of the fuel cell module, the solid oxide fuel cell further comprising:
a gas supply line used for activation that is provided independently of the gas supply line used for power generation inside the fuel cell module; and
a heating means used for activation that heats a gas from the gas supply line used for activation and supplies a high temperature gas to the group of fuel cell cells inside the generator chamber.

2. The solid oxide fuel cell power generation apparatus according to claim 1, wherein the heating means used for activation is a burner for burning a gas used for activation.

3. The solid oxide fuel cell power generation apparatus according to claim 1, further comprising a gas distribution means that distributes the gas used for power generation to the group of fuel cells inside the generator chamber, wherein the gas supply line used for activation supplies the gas used for activation to the gas distribution means in parallel with the gas supply line used for power generation.

4. The solid oxide fuel cell power generation apparatus according to claim 3, wherein the gas supply line used for power generation that is disposed in parallel with the gas supply line used for activation is also provided with a gas heating means inside the fuel cell module.

5. The solid oxide fuel cell power generation apparatus according to claim 4, wherein the gas heating means includes a heat recovery means for recovering an exhaust heat from the fuel cell.

6. The solid oxide fuel cell power generation apparatus according to claim 4, wherein the gas heating means of the gas supply line used for power generation is disposed behind the heating means used for activation, seen from the fuel cell.

7. The solid oxide fuel cell power generation apparatus according to claim 1, further comprising a gas distributor that distributes a gas to the group of fuel cells inside the generator chamber, the gas distributor being provided with a plurality of gas supply ports that receive a supply of gases from the gas supply lines used for activation and used for power generation, respectively.

8. The solid oxide fuel cell power generation apparatus according to claim 7, wherein the gas heating means for heating the gas used for power generation is disposed close to the gas distributor.

9. The solid oxide fuel cell power generation apparatus according to claim 1, further comprising: a temperature sensor for detecting the temperature inside the fuel cell module; and a control device which receives a temperature signal from the temperature sensor and which, when the received temperature signal reaches a predetermined temperature, activates the gas supply line used for power generation to start a supply of the gas used for power generation.

10. The solid oxide fuel cell power generation apparatus according to claim 1, further comprising: a time counting means for counting time after activation of the heating means used for activation; and a control device which receives a time signal from the time counting unit and which, when the received time signal reaches a predetermined time, activates the gas supply line used for power generation to start a supply of the gas used for power generation.

11. The solid oxide fuel cell power generation apparatus according to claim 1, further comprising a control device that operates by switching the supply of gas to the fuel cell inside the generator chamber: from a supply of the gas used for activation; to a simultaneous supply of the gases used for activation and used for power generation; and to a supply of the gas used for power generation, in this order.

12. A solid oxide fuel cell power generation apparatus, comprising:
a plurality of fuel cells each having an anode on one side and a cathode on the other side with an electrolyte provided therebetween;
a fuel cell module including a generator chamber for housing the plurality of fuel cells; an anode gas supply line that supplies an anode gas used for power generation from one side of the fuel cell module;
a cathode gas supply line that supplies a cathode gas used for power generation from the other side of the fuel cell module; and
a gas distributor that distributes the gas used for power generation to the group of fuel cells inside the generator chamber, the solid oxide fuel cell further comprising:
a cathode gas supply line used for activation that supplies a gas used for activation to the gas distributor in parallel with the cathode gas supply line used for power generation inside the fuel cell module;
a burner used for activation that heats a gas from the cathode gas supply line used for activation and supplies a high temperature gas to the gas distributor, the burner used for activation being disposed close to the gas distributor; and
a gas heating means for heating by exhaust heat recovery, the gas heating means being disposed, seen from the fuel cell, behind the gas heating means used for activation inside the fuel cell module, the gas heating means being provided in the cathode gas supply line used for power generation.

13. A power generation method of a solid oxide fuel cell power generation apparatus which comprises a plurality of fuel cells having an anode on one side and a cathode on the other side with an electrolyte provided therebetween; a fuel cell module including a generator chamber for housing the plurality of fuel cells; an anode gas supply line that supplies an anode gas used for power generation from one side of the fuel cell module; and a cathode gas supply line that supplies a cathode gas used for power generation from the other side of the fuel cell module, the method comprising:
a step of supplying a gas used for activation from a gas supply line used for activation, the gas supply line used for activation being provided independently of the gas supply line used for power generation inside the fuel cell module; and
a step of heating a gas from the gas supply line used for activation and supplying a high temperature gas to the group of fuel cell cells inside the generator chamber.

14. The power generation method of a solid oxide fuel cell power generation apparatus according to claim 13, further comprising:
a step of supplying the gas used for activation to a gas distribution means from the gas supply line used for activation;
a step of supplying the gas used for power generation to the gas distribution means in parallel with the gas supply line used for activation; and
a step of dispensing the gas used for activation and the gas used for power generation to the group of fuel cells inside the generator chamber through the gas distribution means.

15. The power generation method of a solid oxide fuel cell power generation apparatus according to claim 14, further comprising an exhaust-heat recovering and heating step of recovering an exhaust heat from the fuel cell and thereby heating the gas used for power generation before the gas used for power generation is supplied to the gas distribution means.

16. The power generation method of a solid oxide fuel cell power generation apparatus according to claim 15, wherein the exhaust-heat recovering and heating step is operated behind the activation gas heating means seen from the fuel cell.

17. The power generation method of a solid oxide fuel cell according to claim 13, further comprising:
a step of detecting temperature inside the fuel cell module; and
a step of activating, in response to that this temperature detection signal has reached a predetermined temperature, the gas supply line used for power generation to start a supply of the gas used for power generation.

18. The power generation method of a solid oxide fuel cell power generation apparatus according to claim 13, further comprising:
a step of counting time after starting to heat a gas from the gas supply line used for activation; and a step of receiving a time signal from this time counting step, and
a step of activating, when the received time signal has reached a predetermined time, the gas supply line used for power generation to start a supply of the gas used for power generation.

19. The power generation method of a solid oxide fuel cell power generation apparatus according to claim 13, wherein the supply of a gas to the fuel cell inside the generator chamber is operated by switching from a supply of the gas used for activation, to a simultaneous supply of the gases used for activation and used for power generation, and to a supply of the gas used for power generation, in this order.
